(19) United States
(12) Patent Application Publication
(10) Pub. No.: US 2006/0032131 A1
(43) Pub. Date: Feb. 16, 2006

(54) Vase holder for balconies

(75) Inventor: Domenico Marchioro, Isola Vicentina (IT)

Correspondence Address: MODIANO & ASSOCIATI, Via Meravigli, 16, MILAN, 20123, IT

(73) Assignee: MARCHIORO S.P.A. STAMPAGGIO MATERIE PLASTICHE

(21) Appl. No.: 11/171,239

(22) Filed: Jul. 1, 2005

(30) Foreign Application Priority Data
Jul. 6, 2004 (IT) PD2004U000057

(51) Int. Cl. A01G 9/02

(52) U.S. Cl. 47/67; 47/68

(57) ABSTRACT

A vase holder for balconies, of the type constituted by a structure for containing a vase with protruding rims, which is supported by two brackets for fixing to a parapet, wall or the like, and is rigidly coupled to the brackets by way of a device for adjusting the distance of the container from the wall. The container is constituted by a frame provided with at least two mutually opposite supporting bars for corresponding rims of the vase.

### BACKGROUND OF THE INVENTION

Currently known vase holders for balconies are formed by a structure for containing a vase, which is supported by two brackets for fixing to a parapet, wall or the like and is rigidly coupled to the brackets by way of means for adjusting the distance of the container from the wall.

Said containment structure for the vase, generally made of metal rod, is constituted by a basket with lateral guides, which are coupled so that they can slide with respect to the wall fixing brackets in order to adjust the distance of the vase holder with respect to said parapet or wall.

The vase that is supported rests on the bottom of said basket.

These known vase holders, once associated with a vase to be supported, do not allow to stack a plurality of identical vases equipped with identical vase holders.

This is greatly inconvenient during storage, packaging and stowage in general, as a consequence of the substantial volume occupied by the vases equipped with the respective vase holder.

The large volume that is occupied indeed entails proportional costs for storage but also for transport.

### SUMMARY OF THE INVENTION

The aim of the present invention is to provide a vase holder for balconies that solves the problems linked to the stacking of known types of vase holder.

Within this aim, an object of the present invention is to provide a vase holder whose functionality is at least equal to that of known types of vase holder.

Another object of the present invention is to provide a vase holder with which it is possible to associate known types of vase.

Another object of the present invention is to provide a vase holder for balconies that can be manufactured cheaply with known systems and technologies.

This aim and these and other objects that will become better apparent hereinafter are achieved by a vase holder for balconies or other constructions provided with a parapet, wall or the like, of the type constituted by a structure for containing a vase with protruding rims, which is supported by two brackets for fixing to a parapet, wall or the like, and is rigidly coupled to said brackets by way of means for adjusting the distance of the container from the parapet, wall or the like, said vase holder being characterized in that said container is constituted by a frame provided with at least two mutually opposite supporting bars for corresponding rims of said vase.

### BRIEF DESCRIPTION OF THE DRAWINGS

Further characteristics and advantages of the invention will become better apparent from the following detailed description of a preferred but not exclusive embodiment thereof, illustrated by way of non-limiting example in the accompanying drawings, wherein:

FIG. 1 is a perspective view of a vase holder according to the invention with a corresponding vase;

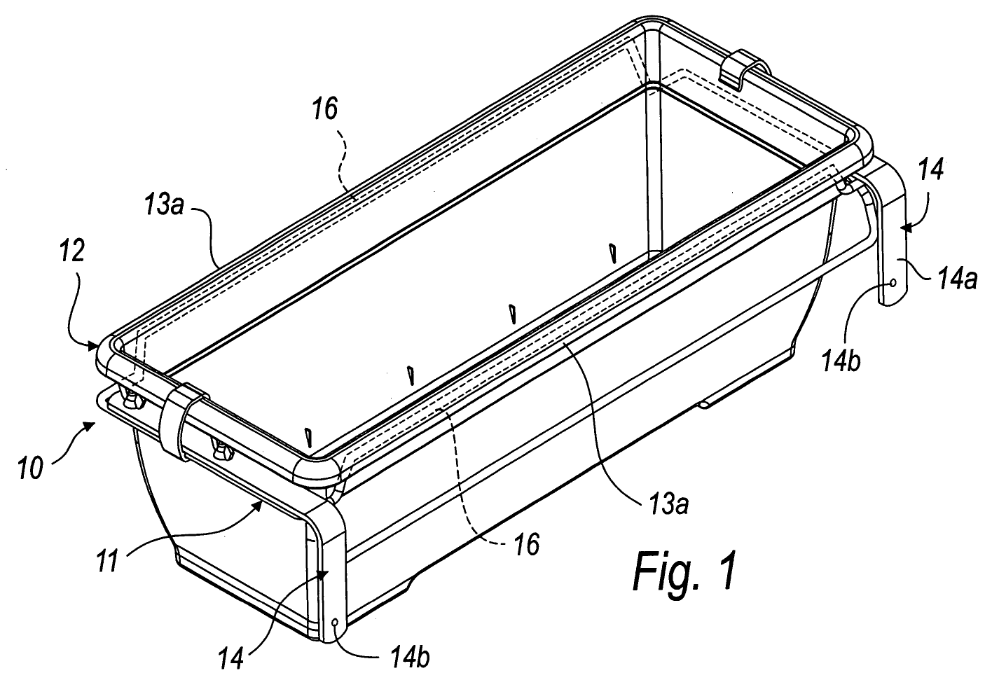

FIG. 2 is an exploded perspective view of a vase holder according to the invention and of its vase;

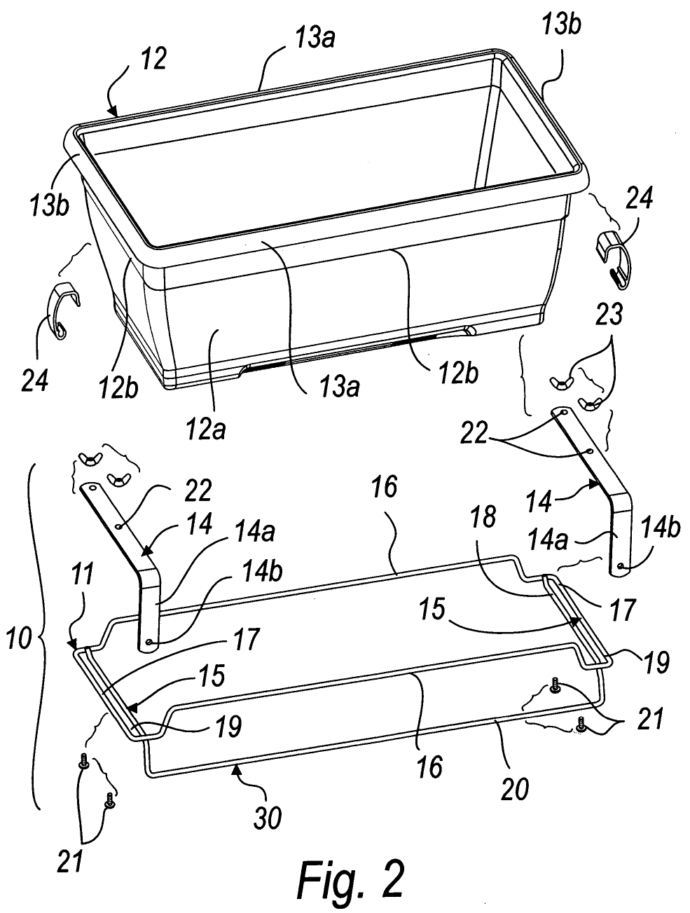

FIG. 3 is a side view of a vase with a vase holder according to the invention;

FIG. 4 is a perspective view of two vases with the vase holder according to the invention in the stacked condition.

### DESCRIPTION OF THE PREFERRED EMBODIMENTS

With reference to the figures, a vase holder for balconies according to the invention is generally designated by the reference numeral 10.

The vase holder 10 is constituted by a containment structure 11 for a vase 12 with protruding rims 13a and 13b.

The first protruding rims 13a are the rim that lies proximate to the wall and the opposite front rim, and the second rims 13b are the lateral rims.

The rims 13a and 13b are preset for handling the vase, allowing easier grip thereof by a user.

The container 11 is supported by two wall fixing brackets 14.

The container 11 is rigidly coupled to the brackets 14 by way of means 15 for adjusting the distance of the container 11 from the wall.

The container 11 is constituted by a frame, which comprises two mutually opposite supporting bars 16 for corresponding rims of the vase 12, which in the example described here are the first rims 13a.

The frame is formed by a border, which is constituted by the pair of mutually opposite supporting bars 16 and by first lateral bars 17, which form, together with second lateral bars 18 that are proximate and parallel thereto, sliding guides. 19 for the elements for coupling the brackets 14 to the container 11; the frame is completed by a substantially U-shaped element 30, which is described in greater detail hereinafter.

The supporting bars 16 and the first lateral bars 17 lie on planes that are parallel but spaced, and the front profile of the border is substantially omega-shaped.

The second lateral bars 18 are joined to each other by a tip-preventing bar 20.

The tip-preventing bar 20 is arranged at the supporting bar 16 that faces the parapet or wall.

The tip-preventing bar 20, by resting against the parapet, prevents the container 11, loaded with a vase 12 that is particularly heavy or unbalanced by a particularly large plant, from flexing forward excessively.

The frame that forms the container 11 is made of metal rod.

The second lateral bars 18 and the tip-preventing bar 20 form a monolithic and substantially U-shaped element 30, which is also made of metal rod.

The U-shaped element 30 is welded to the border constituted by the pair of supporting bars 16 and by the first lateral bars 17, so as to complete the frame.

The means 15 for adjusting the distance of the structure 11 from the parapet or wall are provided by the guides 19 and by the coupling elements that can slide therein.

Said coupling elements are constituted, for each bracket 14, by two threaded elements 21, which pass through respective holes 22 provided in the brackets 14 and for the guides 19.

Corresponding wing nuts 23 for fastening the brackets 14 to the respective guides 19 are screwed onto the threaded elements 21.

The wing nuts 23 facilitate screwing/unscrewing operations, simplifying the adjustment of the distance of the, vase holder 10, and therefore of the vase 12 and of the plants contained therein, from the fixing wall or parapet.

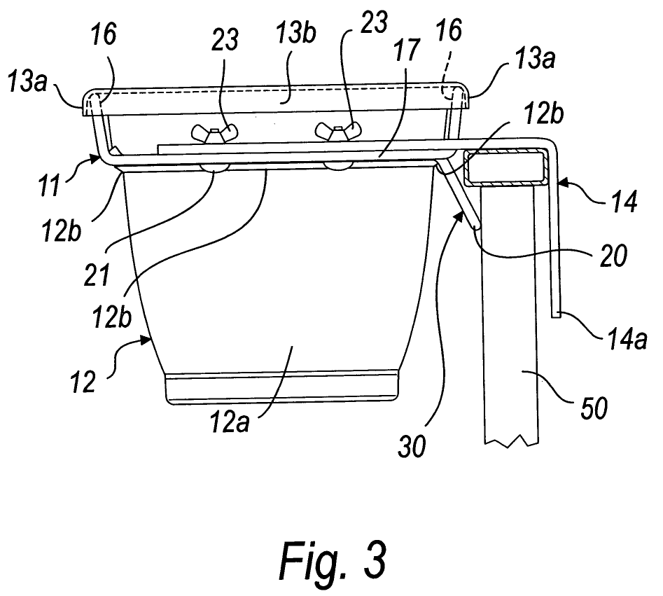

Once the wing nuts 23 have been loosened, the brackets 14 are partially extracted enough to surround a parapet 50, allowing fastening thereto, as shown by way of example in FIG. 3.

The term “parapet” as used herein is intended to mean any structure with a protruding edge suitable for allowing hanging at a vase holder.

Once the vase holder 10 has been installed on the parapet 50, the frame is positioned so that the tip-preventing bar 20 rests against the railing or wall that form the parapet 50.

The brackets 14 have, on their vertical portion 14a, a hole 14b for fixing to a wall.

The lateral rims 13b of the vase 12 can be fixed to the container 11, each by means of a clip 24, which is contoured so as to engage a lateral rim 13b on one side and below the corresponding underlying guide 19 on the other side.

The clip 24 is made of plastic material.

The vase 12 is provided, on its outer lateral surface 12a, with an abutment 12b for resting against the rims 13a and 13b of a further identical vase 12, in which it is stacked.

The abutment 12b is substantially constituted by a perimetric shoulder, which runs along the outer surface 12a, parallel to the rims 13a and 13b.

The frame of the vase holder 10, associated with the vase 12, surrounds the vase 12 below the rims 13a and 13b and above the abutment 12b.

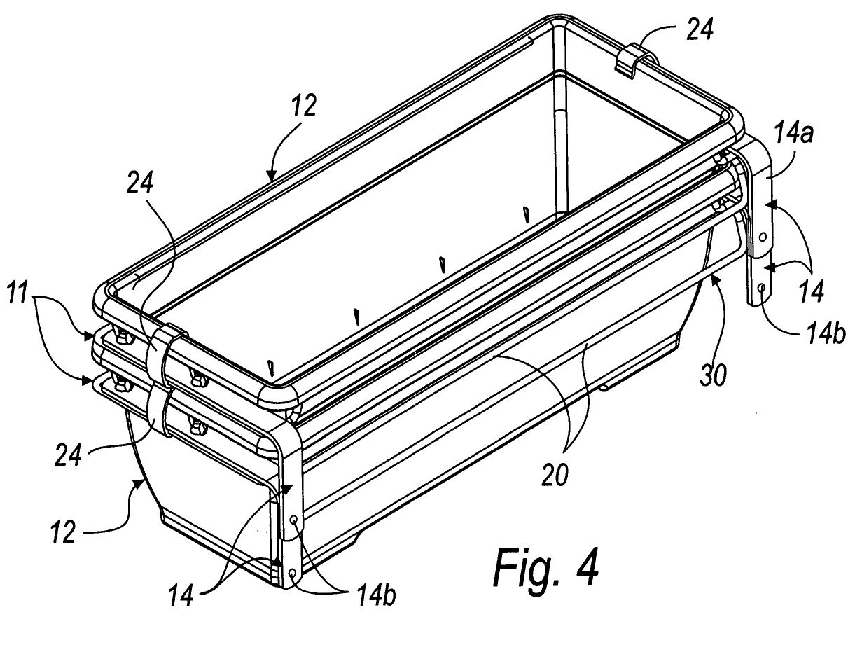

In this manner, as shown in FIG. 4, it is possible to stack a vase 12, equipped with a vase holder 10, on an identical additional vase 12 likewise provided with an additional identical vase holder 10.

In practice it has been found that the invention thus described solves the problems noted in known types of vase holder for balconies.

In particular, the present invention provides a vase holder that solves the problems linked to the stacking of known types of vase holder.

The shape and the dimensions of the frame are in fact such as to not prevent the abutment of the vase 12 from resting on the facing rims 13a and 13b of an underlying additional vase on which it is stacked.

Moreover, the present invention provides a vase holder for balconies whose functionality is at least equal to that of known types of vase holder and is therefore capable of supporting even known types of vase that weigh like known types of vase holder.

Advantageously, the vase holder according to the invention further has the same quality as certain known types of being able to adjust its distance from the fixing wall.

Moreover, the present invention provides a vase holder for balconies that can be manufactured cheaply with known systems and technologies.

In practice, the materials employed, so long as they are compatible with the specific use, as well as the dimensions, may be any according to requirements and to the state of the art.

The disclosures in Italian Patent Application No. PD2004U000057 from which this application claims priority are incorporated herein by reference.

What is claimed is:

1. A vase holder for fixing to a parapet, comprising: a container structure for containing a vase with protruding rims; two supporting brackets for fixing to a parapet; adjustment means for adjusting a distance of the container structure from the parapet, said container structure being rigidly coupled to said brackets by way of said adjustment means and wherein said container structure is constituted by a frame provided with at least two mutually opposite supporting bars for corresponding ones of said protruding rims of the vase.

2. The vase holder of claim 1, wherein said frame is constituted by a border, which is constituted by said pair of mutually opposite supporting bars, by further lateral bars and second lateral bars that are proximate and parallel thereto, said lateral and second lateral bars forming together guides for sliding of coupling elements for coupling said brackets to said container structure.

3. The vase holder of claim 2, comprising a tip-preventing bar for said container structure, which is arranged at the supporting bar that faces the parapet, said second lateral bars being joined by said tip-preventing bar.

4. The vase holder of claim 1, wherein said frame is made of metal rod.

5. The vase holder of claim 2, wherein said adjustment means for adjusting the distance of the container structure from the parapet are provided by said guides and by the coupling elements that are slidable therein.

6. The vase holder of claim 5, comprising coupling elements for coupling said brackets to said container structure, which are constituted, for each bracket, by two threaded elements, which pass through respective holes of said brackets and for said guides, and by corresponding wing nuts for clamping the brackets to the respective guides that are screwed to said threaded elements.

7. The vase holder of claim 2, comprising at least one clip which is contoured so as to engage a lateral one of said protruding rims on one side and below a corresponding underlying guide on the other side, said lateral rim being so fixable to the container structure.

8. The vase holder of claim 7, wherein said at least one clip is made of plastic material.

9. The vase holder of claim 1, wherein said vase has, on an outer lateral surface thereof, an abutment for resting against the protruding rims of an additional identical vase upon stacking of said vase and additional vase.

10. The vase holder of claim 9, wherein said frame is provided so as to surround said vase below said protruding rims and above said abutment, whereby to allow a vase, fitted with said vase holder, to be stacked with an identical additional vase also fitted with an identical additional vase holder.
